(19) United States
(12) Patent Application Publication
(10) Pub. No.: US 2006/0207134 A1
(43) Pub. Date: Sep. 21, 2006

(54) Edge-lit animation display system

(76) Inventor: Brent D. Harry, White Bear Lake, MN (US)

Correspondence Address: Mr. Brent D. Harry, 5250 Grand Ave., White Bear Lake, MN, 55110-2450, US

(21) Appl. No.: 11/085,750

(22) Filed: Mar. 21, 2005

(51) Int. Cl. G09F 19/14

(52) U.S. Cl. 40/453

(57) ABSTRACT

A multiple-sheet edge-lit animation display system is disclosed. The system utilizes a plurality of internally-reflective light-transmitting sheets as components of a stack. Each sheet in the stack has a distinct pattern applied to its surface that represents one frame of a multiple-frame animated image. By sequentially illuminating all the sheets in the stack, the animated image is displayed. Each sheet in the stack has its own dedicated light source instead of a single light source that is mechanically sequenced through all the sheets. This allows a fully-electronic design with no moving parts. A programmable microcontroller is used to sequentially illuminate the sheets electronically. The more advanced preferred implementation uses the microcontroller to perform additional decision-making and timing functions. That specific realization is a nightlight that exhibits an animated display for a predetermined interval any time the room lights are turned off, and ceases the display any time the room lights are turned on. During the predetermined interval, the display begins at full brightness but is slowly faded away until it is gone. Thereafter, the nightlight waits for another transition from light to dark to initiate another predetermined animation interval.

### CROSS-REFERENCE TO RELATED APPLICATIONS

Not Applicable

### STATEMENT REGARDING FEDERALLY SPONSORED RESEARCH AND DEVELOPMENT

Not Applicable

BACKGROUND—FIELD OF INVENTION

This invention relates to multiple-image animation display devices, and specifically to edge-lit multiple-image animation display devices.

### BACKGROUND—DESCRIPTION OF PRIOR ART

During the last century, there has been widespread commercial use of edge-lit displays. This well-known lighting effect is created by illuminating one or more edges of a light-transmitting sheet with a hidden light source. The sheets are composed of internally light-reflective material such as glass or acrylic so that after light enters the sheet, it only escapes where the surface has been intentionally disturbed. The surface can be disturbed by any means such as etching, sandblasting, engraving, molding in bas-relief, or writing with crayon. Wherever the normally smooth surface has been disturbed, the surface glows so that it appears to be the light source itself. The glowing areas can take the form of lettering, line drawings, or three-dimensional scenes by applying the appropriate pattern. Any type of light source can be used, such as neon or fluorescent tubes, light emitting diodes (LEDs), or incandescent bulbs. Some older uses of edge-lighting are now passe, such as for the illumination of automobile speedometers and ‘slide rule’ radio tuning dials. Newer technologies such as electroluminescent panels and vacuum-fluorescent displays continue to supplant the older methods. However, edge-lighting continues to be used in signs and architectural lighting, as well as in more modern applications such as backlighting liquid-crystal displays (LCDS) that are used in computer monitor screens.

Only edge-lit displays that have two or more sheets (as opposed to the common single-sheet displays) are relevant to this particular field of invention. Prior Art describes two distinct types of multiple-sheet edge-lit displays:
(1) Non-changing, with each sheet illuminated by a different color. This produces a constant display with multiple superimposed images appearing in different colors at the same time. See, for example, U.S. Pat. No. 1,707,965 by Scantlebury, filed Nov. 3, 1928.
(2) Changing, with each sheet illuminated at a different time. This produces either a multiple-image animated display or a single image with the illusion of lateral movement, referred to as ‘image motion’ in Prior Art. For examples of animated displays, see U.S. Pat. No. 3,399,476 by Davis, filed Feb. 1, 1965 and U.S. Pat. No. 4,949,489 by Rudell and Gardner, filed Jul. 11, 1989. For an example of image motion, see U.S. Pat. No. 4,975,809 by Ming-ho Ku, filed Sept. 1, 1988.

In the traditional connotation used here, ‘animation’ describes the process of sequentially displaying a set of distinct but related superimposed images so that a figure or object appears to be animated, to change shape or form. For example, a flying bird can be animated by sequentially displaying three distinct superimposed images, with wings up, wings sideways, and wings down. Because of persistence of vision, the bird appears to be animated, to move as if it was alive. One common type of animated display is found in signs that are constructed from superimposed neon tubes that display a set of distinct but related images. When the tubes are sequentially illuminated, the animated image is displayed.

In contrast, ‘image motion’ is different from ‘animation’ because it doesn't involve distinct but related superimposed images. Instead, copies of the same object or image are placed in different locations and are sequentially illuminated. This creates the illusion that an object or image jumps from location to location. One common type of image motion display is found in signs that have ‘chasing lights’ at their borders. Multiple border lights are flashed in sequence to produce the illusion that they constantly jump from one position to the next as they move endlessly around the border of the sign.

Prior Art Examples of Multiple-Sheet Edge-Lit Animated Displays:

A search of Prior Art has uncovered edge-lit animation methods that rely exclusively on outdated mechanical means to sequentially light multiple sheets. Motor-driven mechanisms with gears, belts, camshafts, moveable slits, etc. are used to cause an individual light source to sequentially light multiple sheets one-at-a-time. One example from U.S. Pat. No. 4,949,489 is shown in FIG. 1 as part of a children's drawing toy. A tubular light source 20 supplies light through a color filter 21 that has a set of selectable colored bands 22, 23, and 24. The light is completely blocked by a light shield 25, except where it is allowed to travel through an optical window element 26 into the edge of either a light-transmitting sheet 27 or a light-transmitting sheet 28. A motor-driven mechanism (not shown) causes window element 26 to oscillate ‘back-and-forth’ between the two sheets, alternately lighting them. This is only a two-sheet example, but another illustration in that patent shows three sheets being sequentially illuminated with the same mechanism. However, such an oscillating mechanism limits the type of animation that can be displayed to one with a back-and-forth 1-2-3-2-1 sequence. The bird animation described above requires a repeating 1-2-3-1-2-3sequence instead.

U.S. Pat. No. 4,949,489 states the novelty of using handwritten edge-lit displays for animation. However, “Rite-N-Neon” handwritten edge-lit signs were sold by the Neon Products Company, Inc. of Lima, Ohio in the 1930's. And animated edge-lit displays were already described in U.S. Pat. No. 3,399,476, although that patent didn't detail all the available methods of disturbing the surface. One of the edge-lit animation mechanisms illustrated in U.S. Pat. No. 3,399,476 produces an animation by rapidly spinning a carousel of transparent sheets. The rapid rotation causes the sequential display of a set of distinct but related superimposed images. This is potentially very dangerous, especially if a sheet should crack or become loose. Detailed warnings are also given about the dangers of inadequately cooling the high-power incandescent lamps used in its various embodiments.

Prior Art Example of a Multiple-Sheet Edge-Lit Image-Motion Display:

Conversely, FIG. 2 shows an illustration from U.S. Pat. No. 4,975,809 of ‘image motion’ as opposed to ‘animation’ in the traditional connotation described above.

In FIG. 2, a composite display panel 29 is constructed from a first component layer 30 that includes a first arrow pattern 32, and a second component layer 31 that includes a second arrow pattern 33. However, patterns 32 and 33 are not distinct. They are actually the same arrow pattern placed in two different non-superimposed positions. Instead of sequentially illuminating distinct but related superimposed images, the same arrow pattern is alternately lit in the two different locations. It appears that the same arrow jumps back and forth between the two different locations, just as chasing lights appear to jump from one location to the next around the border of a sign. For the image motion display illustrated in FIG. 2, this patent describes “subject layers illuminated with appropriate edge-disposed light sources not explicitly shown” that are “under the suitable alternated direction of an unillustrated controller”. The controller is not described, but implementing it as a mechanism is one possible implication since a motor-driven color-changing device is illustrated and discussed elsewhere in this patent for single-sheet displays. Also, the term “edge-disposed light sources” does not require the use of a dedicated light source per sheet. That term can describe other arrangements, such as a plurality of light sources sequenced by a mechanical controller. The term ‘alternated’ signifies only two states, in agreement with FIG. 2, and there is no suggestion of using the described image motion effect for more than two sheets. This patent specifically excludes superimposed images for the image motion effect when it describes “patterns non-congruently distributed among alternately-illuminated layers”. This exclusion agrees with FIG. 2 which illustrates two identical patterns that are specifically placed so as not to be superimposed. This same patent states that “Although edge-illuminated panels have in fact been previously utilized in a variety of devices including those which are autonomously energized, this usage has typically been limited to the production of background lighting effects for superposed transparencies or liquid-crystal displays.” Those are only two contemporary applications, and that statement contradicts all the other historical uses. In the last century, there was widespread commercial use of edge-lit displays in signs, radios, and automobile dashboard displays, decades before modem technologies such as liquid-crystal displays were known.

This same patent also states that “The employability and dramatic effectiveness of edge-illuminated panels as self-projecting display elements in autonomously-energized environments apparently has not previously been recognized.” This statement contradicts the widespread (although outdated) commercial use of ‘slide rule’ tuning dials in portable radios that were edge-lit so that stations could be selected in the dark.

Both of the aforementioned Prior Art patents that pertain to animation mention its applicability to signs. The latter Prior Art patent involving image motion makes no mention of signs. Its claims are enumerated specifically for edge-lit displays used in small, self-contained items such as greeting cards, key-chain medallions, and campaign buttons.

### SUMMARY

This invention discloses a multiple-sheet edge-lit system for displaying animated images using a modem microcontroller-based electronic design with no moving parts.

### OBJECTS AND ADVANTAGES

Several objects and advantages of this edge-lit animated display system are:
(a) To provide a simple animation system based on edge-lighting to take advantage of its unique appearance and low cost.
(b) To provide a system that eliminates all mechanisms and moving parts by using a dedicated light source per sheet instead of a single shared light source. This lowers cost, increases reliability, eases manufacturing, and provides safer operation.
(c) To provide a system that eliminates high-power incandescent illumination and its associated heat, which enhances safety while lowering power consumption.
(d) To provide a system that can easily be scaled for different uses, from small battery-powered displays to large signs.
(e) To provide a modem programmable system that can manage other decision-making and timing functions as well as sequencing the animation.

### DRAWING FIGURES

In the drawings, closely related figures have the same number but different alphabetic suffixes.

FIG. 1 is a Prior Art illustration of an edge-lit animation mechanism used in a children's drawing toy.

FIG. 2 is a Prior Art illustration of an edge-lit image motion device used in a greeting card.

FIG. 3 is an exploded perspective view of the basic embodiment.

FIGS. 4A, 4B, and 4C are three patterns which represent three distinct but related images.

FIG. 5 is an assembled perspective view of the basic embodiment.

FIG. 6 is the electronic schematic for the basic embodiment.

FIG. 7 is an illustration of a Personal Computer based system used for programming.

FIG. 8 is an assembled perspective view of the preferred embodiment.

FIG. 9 is the electronic schematic for the preferred embodiment.

FIGS. 10A . . . 10E are waveforms for digital outputs 57, 58, and 59.

FIG. 11A is the bottom Printed Circuit Board (PCB) silkscreen for the preferred embodiment, showing component placement.

FIG. 11B is the bottom PCB artwork for the preferred embodiment, showing etched copper.

FIG. 12A is the top PCB silkscreen for the preferred embodiment, showing component placement.

FIG. 12B is the top PCB artwork for the preferred embodiment, showing etched copper.

FIG. 13 is an assembled perspective view of the first alternative embodiment.

FIG. 14 is the electronic schematic for the first alternative embodiment.

FIG. 15 is an assembled perspective view of the second alternative embodiment.

FIG. 16 is the electronic schematic for the second alternative embodiment.

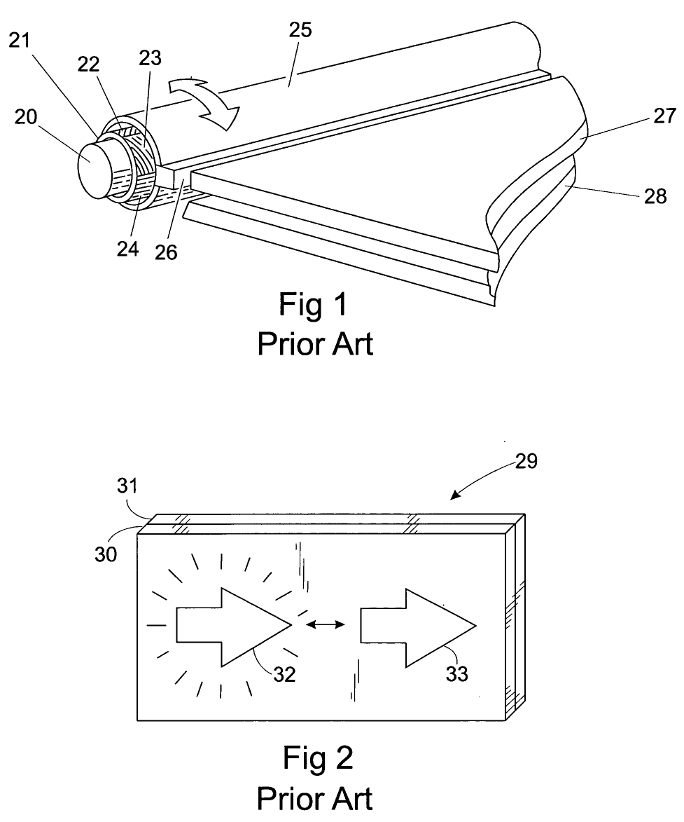

### REFERENCE NUMERALS AND DESIGNATORS IN DRAWINGS

20 tubular light source 50 power supply positive input pin
21 color filter 51 power supply negative input pin
22 selectable colored band 52 programming signal pin, ‘ICSPDAT’
23 selectable colored band 53 programming signal pin, ‘VPP’
24 selectable colored band 54 programming signal pin, ‘ICSPCLK’
25 light shield 55 programming signal pin, ‘VDD’
26 optical window element 56 programming signal pin, ‘GND’
27 light-transmitting sheet 57 first digital output
28 light-transmitting sheet 58 second digital output
29 composite display panel 59 third digital output
30 first component layer 60 personal computer
31 second component layer 61 personal computer monitor
32 first arrow pattern 62 personal computer keyboard
33 second arrow pattern 63 serial port cable
34 composite display stack 64 device programmer
35 first component sheet 65 ICSP programming cable
36 second component sheet 66 second PCB
37 third component sheet 67 second electronic assembly
38 first printed circuit board (PCB) 68 analog detector signal
39 first electronic assembly 69 digital trigger signal
40 power supply 70 third PCB
41 recess for LED1 71 third electronic assembly
42 recess for LED2 72 microphone
43 recess for LED3 73 voice recognition processor
44 recess for LED4 74 gas-discharge tube
45 recess for LED5 75 gas-discharge tube
46 recess for LED6 76 gas-discharge tube
47 recess for LED7 77 fourth PCB
48 recess for LED8 78 fourth electronic assembly
49 recess for LED9 C1 tantalum bypass capacitor
C2 first crystal loading capacitor R4 pull-up resistor
C3 second crystal loading capacitor R5 pull-down resistor
C4 bypass capacitor R6 pull-down resistor
C5 bypass capacitor R7 voltage divider resistor
C6 filter capacitor R8 photocell
D1 diode R9 current-limit resistor
F1 fuse R10 current-limit resistor
LED1 light emitting diode R11 current-limit resistor
LED2 light emitting diode RL1 optically-coupled relay
LED3 light emitting diode RL2 optically-coupled relay
LED4 light emitting diode RL3 optically-coupled relay
LED5 light emitting diode SW1-1 power switch
LED6 light emitting diode SW1-2 mode switch
LED7 light emitting diode T animation frame period
LED8 light emitting diode T1 transformer
LED9 light emitting diode T2 transformer
Q1 switching transistor T3 transformer
Q2 switching transistor U1 microcontroller
Q3 switching transistor U2 Schmitt trigger inverter
R1 emitter resistor VR1 voltage regulator
R2 emitter resistor Y1 quartz crystal
R3 emitter resistor

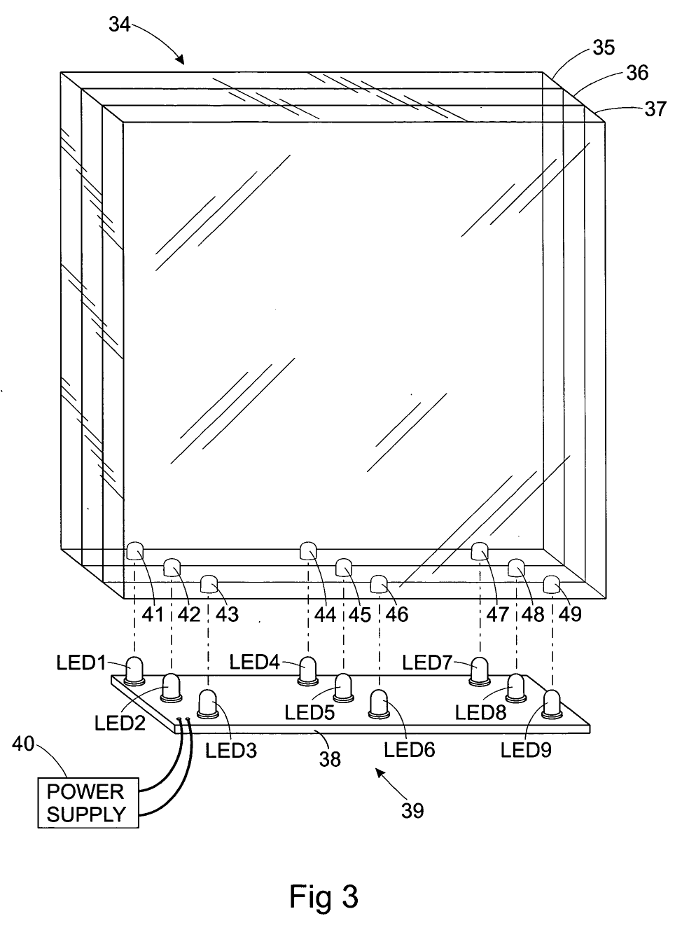

### Description—FIGS. 3, 4A, 4B, 4C, 5, and 6—Basic Embodiment

A portion of the disclosure of this patent document contains material which is subject to copyright protection. A portion of the disclosure of this patent document also contains a trademark logo used in electrical engineering. The copyright and trademark owner has no objection to the facsimile reproduction by anyone of the patent disclosure, as it appears in the Patent and Trademark Office patent files or records, but otherwise reserves all copyright and trademark rights whatsoever.

FIG. 3 is an exploded perspective view of the basic version of the animation display system. A first electronic assembly 39 is constructed from a first printed circuit board (PCB) 38, a set of light emitting diodes (LEDs) named LED 1 . . . LED9, and additional electronic components (not shown in FIG. 3). A composite display stack 34 is constructed by stacking a first component sheet 35 with a second component sheet 36 and a third component sheet 37. Sheets 35, 36, and 37 are composed of a transparent, internally-reflective light-transmitting material such as glass or acrylic. Stack 34 includes a set of physical recesses 41 . . . 49 that receive LED1 . . . LED9 respectively. They are typically drilled holes that are dimensioned to allow the LEDs to be inserted full-length into stack 34, although that is not a requirement. They can be formed by any appropriate method such as molding. A power supply 40 is connected to assembly 39 which is then attached to stack 34 by inserting the LEDs into their respective recesses. The resulting assemblage is then mounted in a suitable base or housing or frame (not shown) to create a complete unit. Power supply 40 can be any suitable battery pack, wall adapter, etc. as is well understood by anyone skilled in the art. If power supply 40 is a battery pack, the resulting unit is completely self-contained.

In FIG. 3, each individual sheet within stack 34 is associated with its own dedicated light source instead of one common light source that is mechanically shared among all the sheets. (In this context, ‘light source’ signifies a plurality of LEDs that are lit together as a group.) Sheet 35 is associated with [LED1, LED4, and LED7]. Sheet 36 is associated with [LED2, LED5, and LED8]. Sheet 37 is associated with [LED3, LED6, and LED9].

As well as easing the manufacturing assembly process, recesses 41 . . . 49 shown in FIG. 3 improve light transmission from the LEDs into their respective sheets for a brighter display. They also ensure that the light from each LED is directed only into its respective sheet so that only one image is lit at a time. However, the recesses are not required for the animation system to function. If recesses 41 . . . 49 are eliminated, assembly 39 can be physically attached to stack 34 with brackets or glue or any other suitable method instead. Without recesses, light from the LEDs can be adequately directed into their respective sheets with proper alignment only. However, light transmission can be improved by bonding LED1 . . . LED9 to their respective sheets with clear glue such as generic epoxy. This is because the bonds form transparent, internally-reflective light pipes that direct the light from the LEDs into their respective sheets. These bonds also serve the dual purpose of physically attaching assembly 39 to stack 34. For sheets that are thinner than the LED width, other methods are needed to direct the light from each LED only into its respective sheet. Such methods include using light-blocking paint, staggering the sheet edges, generic light pipes, or optical fibers, for example.

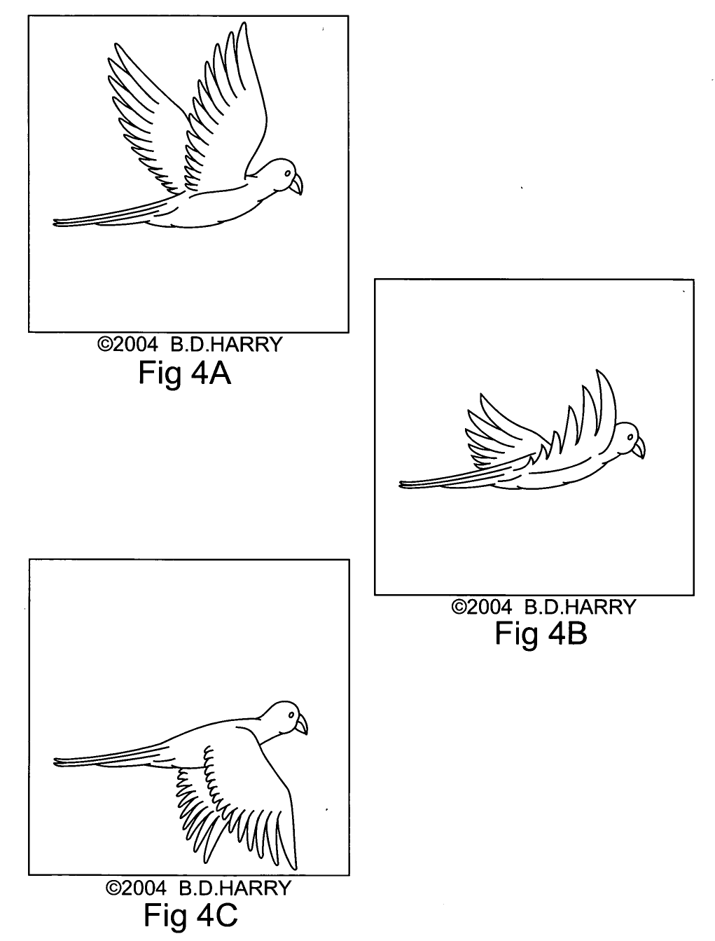

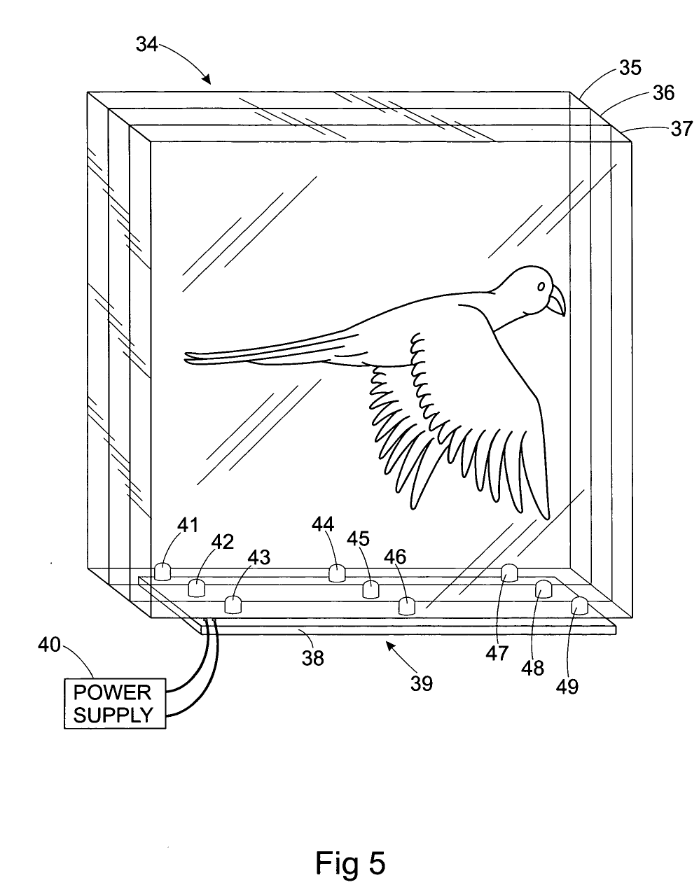

Not illustrated in FIG. 3 for clarity, each of the sheets 35, 36, and 37 has a distinct image applied to its surface by engraving or by any other means as previously described. FIGS. 4A, 4B, and 4C illustrate an example set of three distinct but related patterns that represent three superimposed images to be sequentially displayed. The images are of a flying bird with wings up, wings sideways, and wings down. FIG. 4A is used as the pattern for Sheet 35, FIG. 4B is used as the pattern for Sheet 36, and FIG. 4C is used as the pattern for Sheet 37. FIG. 5 is an assembled perspective view of the basic embodiment. Assembly 39 has been attached to stack 34 by inserting LED1 . . . LED9 into their respective recesses 41 . . . 49. For clarity, only one sheet within stack 34 is illustrated as having been engraved. That is sheet 37, which has been engraved with the pattern from FIG. 4C.

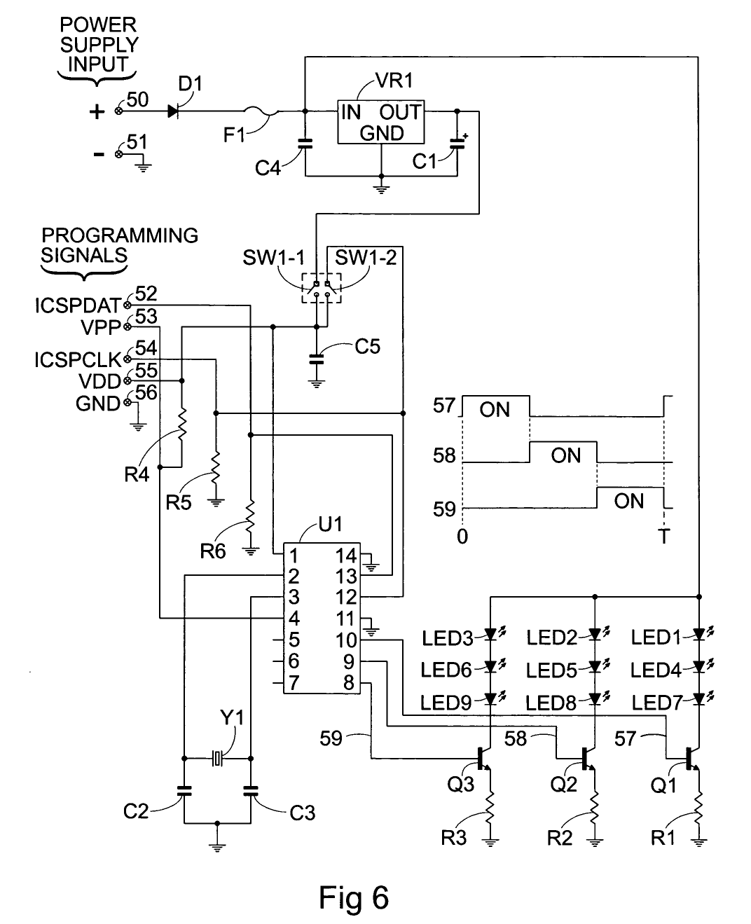

FIG. 6 illustrates the schematic diagram for assembly 39 used in the basic embodiment. The corresponding PCB 38 is not shown in detail as it can be created from FIG. 6 and the associated descriptions. A programmable microcontroller U1 is connected to driver circuitry that controls LED1 . . . LED9. A first digital output 57 from microcontroller U1 is connected to a driver transistor Q1 that controls LED1, LED4, and LED7 as a group. An emitter resistor R1 determines the current through transistor Q1 and therefore the maximum brightness of LED1, LED4, and LED7. A second digital output 58 is connected to a driver transistor Q2 that controls LED2, LED5, and LED8 as a group. An emitter resistor R2 determines the current through transistor Q2 and therefore the maximum brightness of LED2, LED5, and

### Description—FIGS. 3, 4A, 4B, 4C, 5, and 6—Basic Embodiment (continued)

LED8. A third digital output 59 is connected to a driver transistor Q3 that controls LED3, LED6, and LED9 as a group. An emitter resistor R3 determines the current through transistor Q3 and therefore the maximum brightness of LED3, LED6, and LED9.

The timing of digital outputs 57 . . . 59 can be seen from the simple waveform that is part of the schematic diagram of FIG. 6. Digital outputs 57 . . . 59 are turned on one-at-a-time in a repeating sequence. The duration of one complete three-frame animation cycle is known as a period T by anyone skilled in the art. Period T is a programmed parameter that was empirically chosen to be 480 ms. Each digital output is turned on for one third of this period T, but in general the individual frame durations don't need to be equal. The amplitudes of all waveforms are equal to the output voltage of regulator VR1, which is recommended to be 3 Volts.

Microcontroller U1 is a ‘Complementary Metal-Oxide Semiconductor’ (CMOS) device for the lowest possible power consumption. It contains built-in flash memory that retains its programming instructions with no power applied, so it only needs to be programmed once. Programming is performed with a modern protocol named ‘In-Circuit-Serial-Programming’ (ICSP) by temporarily connecting a five-pin interface to assembly 39 as explained later. As illustrated in FIG. 6, a set of programming input pins 52 . . . 56 receive the programming signals named ‘ICSPDAT’, ‘VPP’, ‘ICSPCLK’, ‘VDD’, and ‘GND’, respectively. Connections are made to these five pins only briefly during programming.

As illustrated in FIG. 6, microcontroller U1 is connected to a quartz crystal Y1, a first crystal loading capacitor C2, and a second crystal loading capacitor C3. These components have specific values to allow microcontroller U1 to run at the very slow clock frequency of 32.000 kHz. This frequency is customary for ultra-low-power battery-operated systems, to minimize power consumption. Changing the crystal frequency would change the animation rate by the same factor unless the program was modified to account for the different frequency.

The disclosed animation system can be translated into another type of microcontroller by anyone skilled in the art, but that would require a different device-specific program to be written.

As illustrated in FIG. 6, power is applied to assembly 39 through a positive power supply input pin 50 and a negative power supply input pin 51. These are the only two permanent connections made to assembly 39. These two input pins receive power from power supply 40 (not shown in FIG. 6). The positive power supply input travels through a diode D1 that prevents damage caused by the inadvertent application of reverse polarity. A fuse F1 prevents damage caused by short circuits. A voltage regulator VR1 reduces the input voltage to a relatively low voltage for use by microcontroller U1. A bypass capacitor C1 and a bypass capacitor C4 are required by regulator VR1 for stability. A bypass capacitor C5 reduces switching noise that is generated by microcontroller U1.

The output voltage of regulator VR1 is constant regardless of the voltage supplied by power supply 40. To minimize the power consumption of microcontroller U1, the recommended device for regulator VR1 supplies the customary value of 3 Volts for ultra-low-power battery-operated systems. A different voltage regulator could be used instead that supplies any voltage tolerated by microcontroller U1. Power supply 40 can supply any voltage tolerated by regulator VR1 and transistors Q1 . . . Q3.

Regulator VR1 supplies 3 Volt power to microcontroller U1 during normal operation. This is much lower than the programming voltage that is impressed upon microcontroller U1 briefly during programming. Because of this voltage difference, it is necessary during programming to isolate microcontroller U1 from regulator VR1 and its bypass capacitor C1 to prevent damage. As shown in FIG. 6, this is done with a power switch SW1-1, which is also used to turn the animation system on and off during normal use. If not for the probability of damage, power would instead be disconnected at positive power supply input pin 50. Therefore, regulator VR1 always receives power from power supply 40 even when power switch SW1-1 is turned off. That is why regulator VR1 is recommended to be an ultra-low quiescent current device.

A mode switch SW1-2 normally remains in the continuous mode (on) position except during programming, when it is turned off to isolate the ‘ICSPCLK’ signal on programming input pin 54. A pull-up resistor R4 causes microcontroller U1 to receive 3 Volt power except during programming. A pull-down resistor R5 and a pull-down resistor R6 cause the dedicated programming input signals, ‘ICSPCLK’ and ‘ICSPDAT’ to default to ground.

### Description—FIGS. 3, 4A, 4B, 4C, 5, and 6—Basic Embodiment (continued)

Only microcontroller U1, crystal Y1, and its loading capacitors C2 and C3 have essential values. All recommended components used in the schematic diagram of FIG. 6 have industry-standard packages and are readily available from electronics suppliers:
C1=22 uF low-leakage tantalum capacitor (polarized 3528 package)
C2, C3=33 pF NPO ceramic chip capacitors (1206 package)
C4, C5=100 nF ceramic chip capacitors (1206 package)
D1=BAV99 diode (SOT-23 package)
F1=50 mA fuse (microSMD005 package)
LED1 . . . LED9=high-intensity LEDs (T-1 or T-1¾ through-hole package)
Q1 . . . Q3=PZT3904 driver transistors (SOT-223 package)
R1 . . . R3=75 Ω chip resistors (1206 package)
R4=10 KΩ chip resistor (1206 package)
R5, R6 =301 KΩ chip resistors (1206 package)
SW1-1=half of dual DIP switch (power switch, SMT package)
SW1-2=half of dual DIP switch (mode switch, SMT package)
U1=Microchip # PIC16F630-I/SL (CMOS flash-memory programmable microcontroller, SO-14 package)
VR1=National Semiconductor # LM2936M-3.0 (U1tra-Low Quiescent Current voltage regulator with 3 Volt output, SO-8 package)
Y1=Citizen # CM250S32.000KAZFT (32.000 kHz quartz crystal with 12.5 pF loading, SMT crystal package)
   Pin Definitions for Microcontroller U1:

The following pin definitions for microcontroller U1 are predetermined by the program listing and use the manufacturer's pin naming conventions. These definitions are not needed to build or operate the animation system, and are provided merely for full disclosure.
Pin 1=Vdd (positive power input)
Pin 2=OSC1 (first crystal oscillator input)
Pin 3=OSC2 (second crystal oscillator input)
Pin 4=Vpp (elevated positive power for programming only)
Pin 5=RC5 (unused input/output pin)
Pin 6=RC4 (unused input/output pin)
Pin 7=RC3 (unused input/output pin)
Pin 8=RC2 (input/output pin defined as digital output 59)
Pin 9=RC1 (input/output pin defined as digital output 58)
Pin 10 32 RC0 (input/output pin defined as digital output 57)
Pin 11=RA2 (input/output pin defined as digital trigger input)
Pin 12=RA1 (input/output pin defined as digital mode input)
Pin 13=RAO (input/output pin used only for programming)
Pin 14=Vss (ground=negative power input)

To create the loadable program, the following 31-line listing must be entered verbatim in an ASCII text editor (such as Microsoft Notepad®) that does not add hidden formatting characters (as Microsoft Word® does). The file is saved with an arbitrary filename such as ‘program.hex’ and is loaded into the microcontroller according to the process described later. It only uses the ‘colon’ character and the hexadecimal (base-16) numerals 0 . . . 9 and A . . . F.

Program Listing

:020000040000FA
:06000000000040207528FD
:08000800A000030E8312A10009
:1000100087010C1C3A28A31818282608023C031D47
:100020001828A50B18282408031DA4036B30A5006D
:100030001D30260703188A0A820020282928322822
:100040000130A600FB308F008E010C100F308100B4
:100050003B280230A600FB308F008E010C100F30C1
:1000600081003B28A601FB308F008E010C100F3061
:1000700081003B284020210E8300A00E200E0900A5
:100080008316C23081008312073099008316063030
:100090008500950106309600831285018316003095
:1000A00087008316990101308C00C8308B008312C1
:1000B0008C0183168E018312A601A301A201C9201F
:1000C00005080239031DA31405080439031D23156F
:1000D0006B30A5001030A400FB308F008E01810131
:1000E00001308700093090000800A3187C282408FC
:1000F0000319CF28231DCF288130260703188A0A29
:10010000820084289B28B22800302602031D75280F
:1001100001308700A31875282408103C031975289E
:10012000810124080102031C91288701103001027B
:10013000031C9628752801302602031D75280230FD
:100140008700A31875282408103C0319752881011D
:1001500024080102031CA828870110300102031C97
:10016000AD28752802302602031D7528043087004B
:10017000A31875282408103C031975288101240848
:100180000102031CBF28870110300102031CC42890
:1001900075284F30A2000000A20BCB280800870171
:0601A00063000000752859
:02400E00203E52
:000000001FF
   Advantages

From the above description, a number of advantages of this edge-lit animation system are apparent:

(a) By incorporating a dedicated light source per sheet instead of sharing a single light source, all mechanisms have been eliminated. This reduces cost, increases reliability, eases manufacturability, and increases safety.

(b) Power consumption is further reduced by using CMOS electronics with a low clock rate, and high-efficiency LEDs as light sources.

(c) Programmability provides flexibility so that parameters such as frame rate can easily be changed, or other features such as timing and decision-making functions can easily be added.

(d) The display can be scaled from very small to very large without changing its basic structure or program, by changing only the sheet size and the number of individual light sources that are lit together as a group for each sheet.

### Operation—FIGS. 4A, 4B, 4C, 5, and 6—Basic Embodiment

The schematic diagram of FIG. 6 illustrates that the core of assembly 39 is microcontroller U1. Mode switch SW1-2 always remains in its on position except during programming. In normal operating mode, when power switch SW1-1 is turned on, microcontroller U1 repeatedly sequences its three digital outputs 57 . . . 59 according to the internally stored program. This causes each group of LEDs to be sequentially illuminated one-at-a-time. The associated sheets 35, 36, and 37 are thereby illuminated one-at-a-time, causing the respective patterns of FIGS. 4A, 4B, and 4C to be illuminated one-at-a-time. This produces a repeating animated display until power switch SW1-1 is turned off.

The assembled animation display system illustrated in FIG. 5 will not be operational until the program has been loaded into the flash memory of microcontroller U1 as explained ahead.

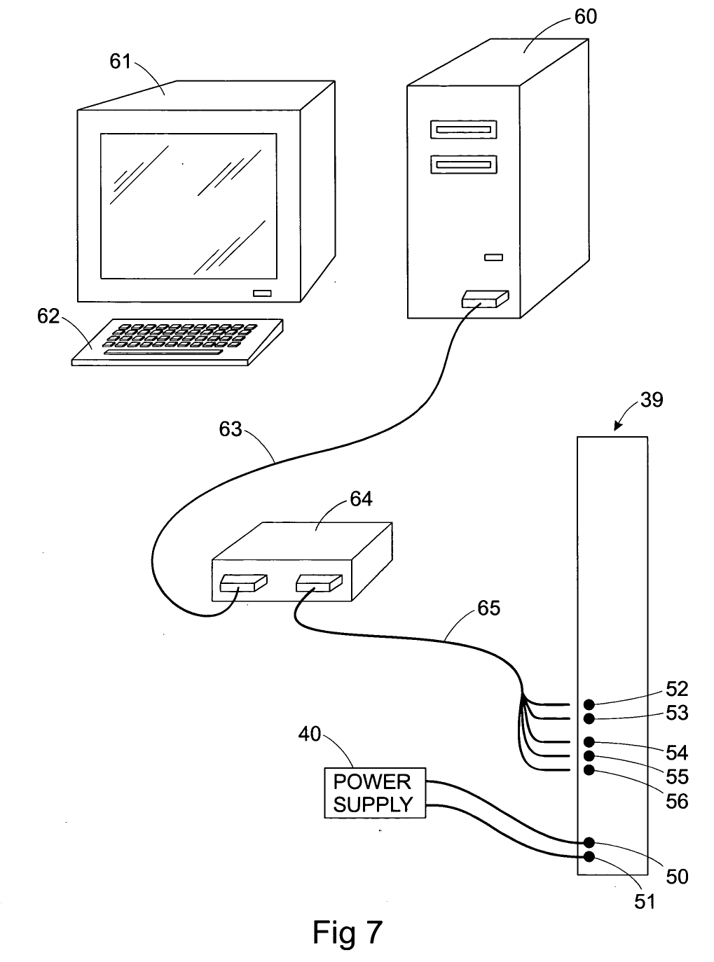

### Operation—FIG. 7—Programming

FIG. 7 illustrates the standard equipment and connections needed to perform In-Circuit-Serial-Programming on assembly 39 through the five-pin ICSP interface. Programming can be performed at any time before or after assembly 39 has been connected to power supply 40, even after it has been installed in the final product. During programming, microcontroller U1 must always be isolated from its surrounding circuitry by turning off both switches SW1-1 and SW1-2.

Human-readable assembly-language source code must be assembled (converted) into machine-readable object code before it can be loaded into the microcontroller as an operating program. That assembly step was already done, and the result is the ‘program.hex’ file of the above program listing. This file is the program that is loaded into microcontroller U1 as described ahead.

It will generally be least problematic to obtain programming hardware and software from the microcontroller manufacturer, Microchip, Inc. Microchip supplies a powerful ‘Integrated Development Environment’ software suite named MPLAB that is freely downloadable from the Microchip website. The advantage of this software suite is that it provides a universal environment for writing source code, assembling source code into object code, and then programming physical devices with a variety of Microchip hardware. MPLAB can be loaded on a Personal Computer that is running any of the standard Microsoft Windows® operating systems such as Windows XP®. The source code for the disclosed program listing was written in Microchip ‘MPASM’ assembly language and then assembled into hexadecimal object code, both from within MPLAB.

The following discussion explains how to program the microcontroller with only one of several available Microchip hardware products. Other companies also supply different hardware and software to program Microchip microcontrollers, so there is not one programming approach. If hardware and software from a different manufacturer are used to program microcontroller U1, the same ‘program.hex’ file is still loaded. FIG. 7 illustrates a personal computer 60 interconnected with a monitor 61 and a keyboard 62 (cabling not shown). Computer 60 is loaded with the Windows XP® operating system and MPLAB. A Microchip ‘Pro Mate II’ device programmer 64 is connected to computer 60 with a serial port cable 63. Device programmer 64 is temporarily connected to assembly 39 through a five-conductor ICSP programming cable 65. The five ICSP signals are a subset of those available at the output of device programmer 64. The five ICSP signals are connected to input pins 52 . . . 56 of assembly 39 as described above.

After device programmer 64 is temporarily connected to assembly 39 using ICSP programming cable 65, programming is accomplished by using MPLAB to load the previously listed ‘program.hex’ file into the microcontroller's flash memory. After the program has been loaded, ICSP programming cable 65 is disconnected from assembly 39.

After this programming step, assembly 39 is connected to power supply 40 and it is ready to be operated by turning on power switch SW 1-1.

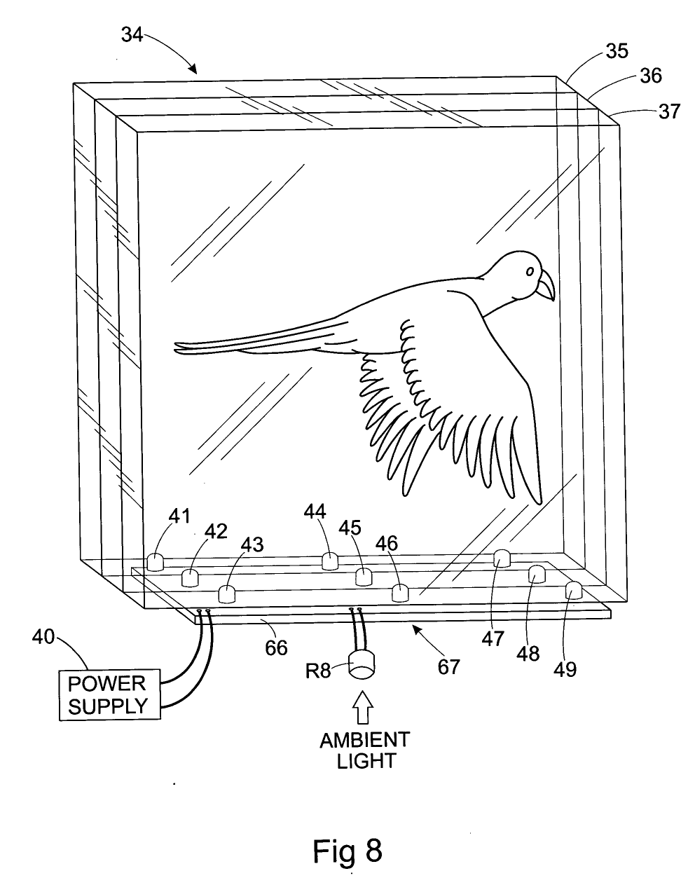

### Description—FIGS. 8, 9, 11A, 11B, 12A, and 12B—Preferred Embodiment

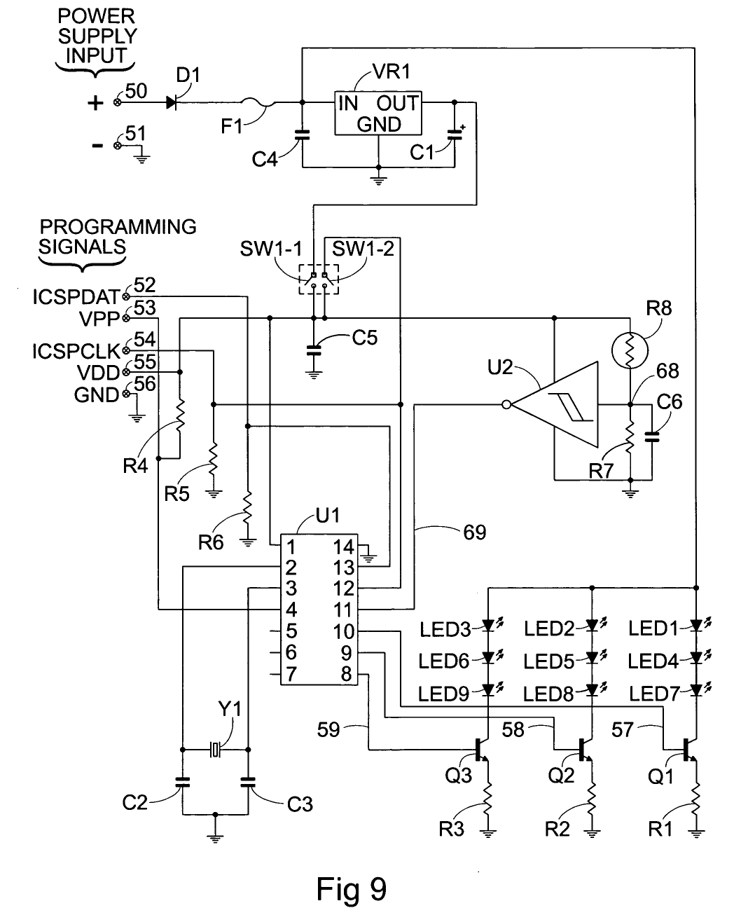

FIGS. 8 and 9 are an assembled perspective view and schematic diagram for the preferred embodiment. The preferred embodiment is nearly identical to the basic embodiment, except that it includes four additional components to detect and act upon changes in ambient light. These are a photocell R8, a resistor R7, a filter capacitor C6, and a Schmitt trigger inverter U2. FIG. 8 illustrates a second electronic assembly 67 that is constructed from a second PCB 66 and all the components illustrated in the schematic diagram of FIG. 9 (of these, only R8 is shown in FIG. 8).

Photocell R8 is a light detector that changes from high resistance when dark to low resistance when light. In the schematic diagram of FIG. 9, photocell R8 is connected to resistor R7 to create a voltage divider that generates a light-sensitive analog detector signal 68. Signal 68 is relatively high voltage when light and relatively low voltage when dark. Filter capacitor C6 provides a low-pass response to signal 68 to prevent spurious responses. Schmitt trigger inverter U2 converts the relatively slowly-changing analog signal 68 into an abruptly-changing digital trigger signal 69 so that it can be used as one of two logical inputs by microcontroller U1. Digital signal 69 is supplied to microcontroller U1 such that the triggering event is a low to high transition, caused by the light level changing from light to dark.

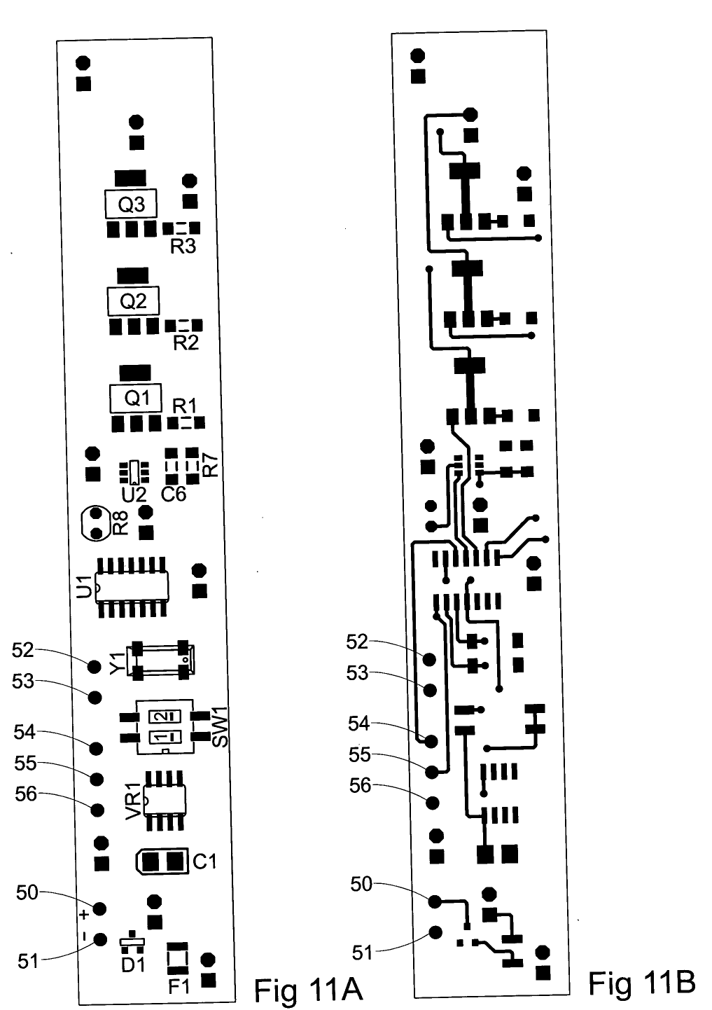

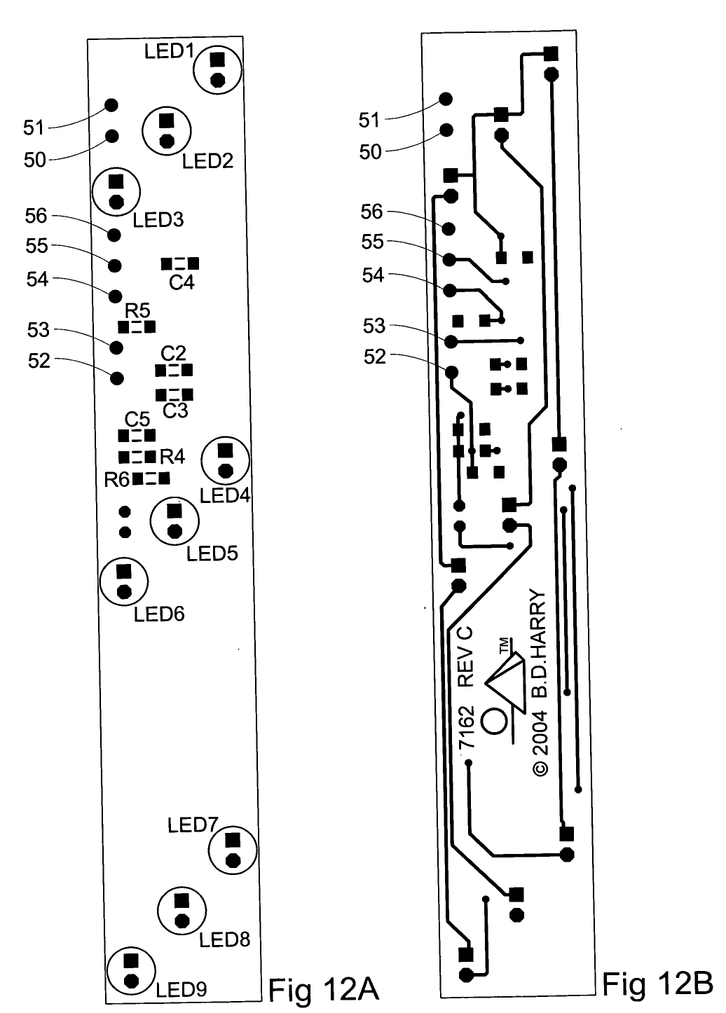

FIGS. 11A, 11B, 12A, and 12B illustrate the artwork for PCB 66. This artwork is reproduced from an actual manufactured prototype, so FIG. 12B includes a copyright notice, a trademark logo, a part number (7162) and the latest revision level (REV C). FIG. 11A illustrates the bottom silkscreen for component placement. FIG. 11B illustrates the bottom etched copper. FIG. 12A illustrates the top silkscreen for component placement. FIG. 12B illustrates the top etched copper. Pins 52 . . . 56 are located on PCB 66 in an arbitrary non-symmetric pattern to prevent the programming signals from being connected backwards. To match the industry-standard packages mounted on it, the manufactured dimensions of PCB 66 are 119.4 mm×19.05 mm. The narrow dimension was arbitrarily chosen to match the thickness of stack 34 when constructed from standard 6.35 mm acrylic. The spacing of LED1 . . . LED9 was also chosen to match this standard thickness. However, the dimensions of both the PCB and the sheets are immaterial to the functioning of the animation system.

Assembly 67 of the preferred embodiment is nearly identical to assembly 39 of the basic embodiment, except that it includes the four additional components C6, R7, R8, and U2. The preferred embodiment uses the same program as the basic embodiment because the basic embodiment doesn't utilize all the program's available features. Assembly 67 is connected to the programming hardware and programmed by the same method used to program assembly 39 of the basic embodiment.

The schematic diagram of FIG. 9 illustrates the four additional components C6, R7, R8, and U2 used in the preferred embodiment. They have industry-standard packages and are readily available from electronics suppliers. Their recommended values are:
C6=100 nF ceramic chip capacitor (1206 package)
R7=301 KΩ chip resistor (1206 package)
R8=Photonic Detectors # PDV-P9203 (Cadmium Sulfoselenide Photoconductive Photocell, through-hole package)
U2=Texas Instruments# SN74LVC2G14DBVR (CMOS Schmitt-Trigger Inverter, operable at 3V, SOT-23/6 package)

### Operation—FIGS. 8, 9, and 10A-10E—Preferred Embodiment

FIGS. 8 and 9 are an assembled perspective view and schematic diagram for the preferred embodiment. It is a light-detecting nightlight that ‘goes to sleep’ whenever ambient light is present, and displays a flying bird or other desired animation whenever it detects a change in ambient light from light to dark. This would typically be caused by a room light being turned off in the evening. The predetermined duration of the animation, referred to as the ‘animation interval’, is a programmed parameter, arbitrarily chosen to be approximately fifteen minutes. During the animation interval, the display starts at full brightness and is faded away until it is gone at the end of the interval. Then the nightlight goes back to sleep, waiting for another change in ambient light from light to dark. If ambient light is detected anytime during an active animation interval, the animation ceases and the nightlight returns to sleep. This would typically occur when a room light is turned on again while the animation is running. Sleep mode is an extremely low power state that has demonstrated repeated daily use for a period of several months with only one set of batteries.

See FIG. 9. The animation display system is activated by turning on power switch SW1-1. Microcontroller U1 then monitors its two logical inputs and decides when to drive the LEDs according to its internally stored program. The first logical input is the digital trigger signal 69 generated by photocell R8. The second logical input is from mode switch SW1-2 that is used to select between continuous mode (on) and light-detecting mode (off). In continuous mode, the animated display will run continuously at full brightness, regardless of light level, just as it does in the basic embodiment. But in light-detecting mode, microcontroller U1 diminishes the display brightness during the predetermined animation interval. It does this by reducing the duty cycle of digital outputs 57 . . . 59 from 100% at full brightness to 0% at zero brightness. The duty cycle of a signal is the ratio of time-on to time-off, as is well understood by anyone skilled in the art.

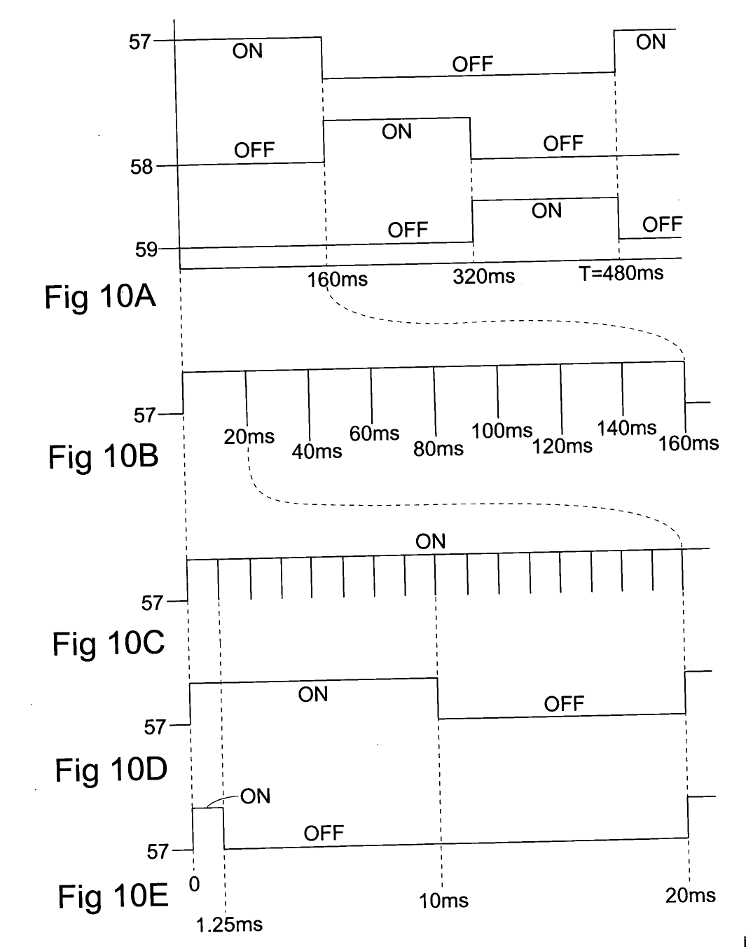

FIGS. 10A-10E illustrate the timing of digital outputs 57 . . . 59 when used in either continuous mode or light-detecting mode. All illustrated waveforms share a common zero time reference, but not the same time scale. The waveforms of FIG. 10A result when operating in continuous mode. These are identical to the waveforms illustrated in FIG. 6 for the basic embodiment. The amplitudes of all waveforms are equal to the output voltage of regulator VR1, recommended to be 3 Volts. Digital outputs 57 . . . 59 are turned on one-at-a-time in a repeating sequence that has animation frame period T equal to 480ms as previously described. The display operates indefinitely at full-brightness, just as the basic embodiment does.

FIGS. 10B . . . 10E illustrate the timing of digital output 57 when operating in light-detecting mode, during which the brightness of the display is diminished from full-brightness to zero. Digital outputs 58 and 59 are not shown because they operate in the same manner as digital output 57. Referring to FIG. 10A, the ‘ON’ duration of digital output 57 is 160 ms. This is one third of the repeating animation frame period T. It represents one of three animation frames. FIG. 10B shows a magnified view of just the ‘ON’ duration of digital output 57. FIG. 10B shows how this ‘ON’ duration is broken into eight sub-pulses of 20ms duration each. It is the duty cycle of these eight sub-pulses that is adjusted to control the display brightness in light-detecting mode. The display brightness is diminished by pulsing the digital outputs on-and-off with a diminishing ratio of on-time to off-time. FIGS. 10C . . . 10E illustrate further-magnified views of the sub-pulses for three different duty cycles. It can be seen that the 20ms sub-pulses are divided into sixteen increments of approximately 1.25 ms. The number of increments that are turned on within each sixteen-increment sub-pulse is varied from 16 . . . 0. FIG. 10C illustrates sub-pulses that are turned on for all of the sixteen increments, so the duty cycle is 16/16 or 100% for full-brightness. FIG. 10D illustrates sub-pulses that are turned on for half of the sixteen increments, so the duty cycle is 8/16 or 50% for half-brightness. FIG. 10E illustrates sub-pulses that are turned on for only one of the sixteen increments, so the duty cycle is 1/16 or 6.25% for 1/16 brightness. For a given duty cycle, all the 20 ms sub-pulses look identical.

While in continuous mode, microcontroller U1 repeatedly sequences the animation frames at constant brightness as it does in the basic embodiment. When in light-detecting mode, it performs three additional functions:
It monitors its two logical inputs from photocell R8 and mode switch SW1-2 to decide when to initiate an animation interval and when to go to sleep.
It times the animation interval.
It reduces the display brightness from maximum to zero during the animation interval.

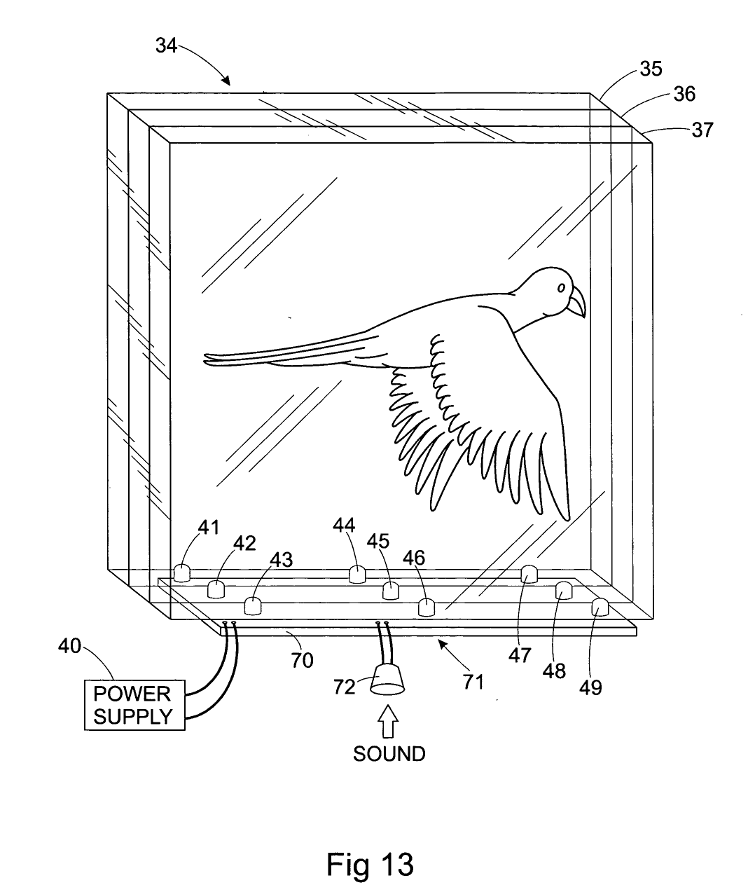

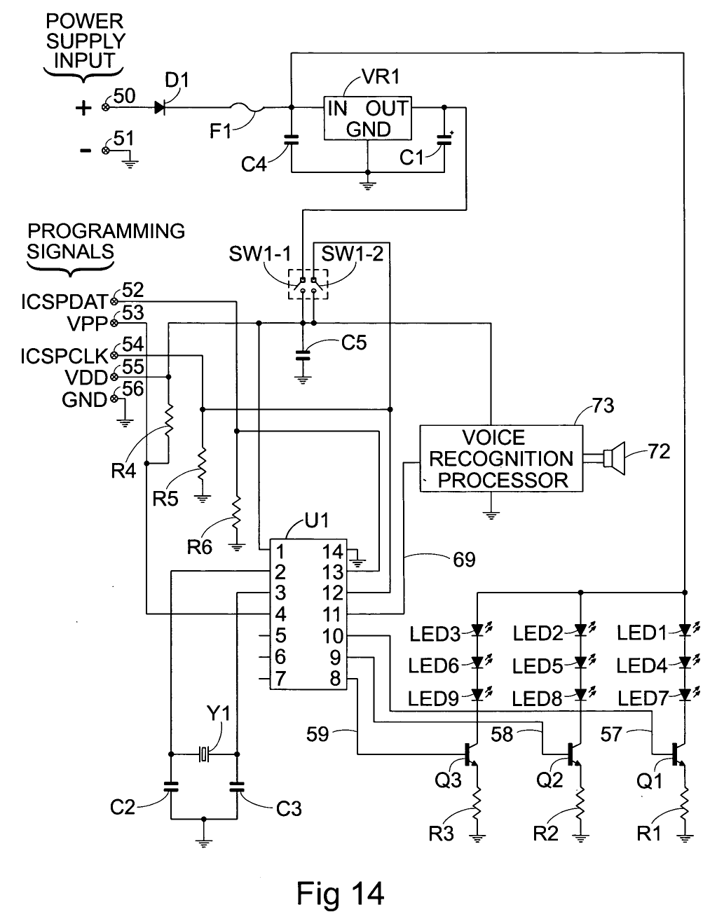

### Description—FIGS. 13 and 14—First Alternative Embodiment

FIGS. 13 and 14 are an assembled perspective view and schematic diagram for a first alternative embodiment. This first alternative embodiment is nearly identical to the preferred embodiment, except that it includes a microphone 72 and a voice-recognition processor 73 in place of the light-activated components (C6, R7, R8, and U2). These sound-activated components allow this first alternative embodiment to initiate an animation interval after detecting a sound instead of a change in light. For example, it could initiate an animation interval upon detecting the sound of a baby crying. FIG. 13 illustrates a third electronic assembly 71 that is constructed from a third PCB 70 and all the components illustrated in the schematic diagram of FIG. 14 (of these, only microphone 72 is shown in FIG. 13).

Voice recognition processor 73 is a conventional device known to anyone skilled in the art. It is an inexpensive single-chip device that is readily available from multiple manufacturers, for example:

Sensory, Inc., Santa Clara, Calif.

Summa Group, San Francisco, Calif.

Primestar Technology, Alhambra, Calif.

Advanced Recognition Technologies, Simi Valley, Calif.

OKI Semiconductor, Sunnyvale, Calif.

Voice recognition processor 73 can either be speaker-dependent, trained to recognize a specific sound, or speaker-independent to recognize general speech. Digital trigger signal 69 is supplied to microcontroller U1 such that the triggering event is a low to high transition, caused by the detection of a specific sound.

### Operation—FIGS. 13 and 14—First Alternative Embodiment

The first alternative embodiment is programmed identically to the preferred embodiment as previously described. Except for the difference in the specific environmental parameter that is detected (sound versus light), the first alternative embodiment operates identically to the preferred embodiment.

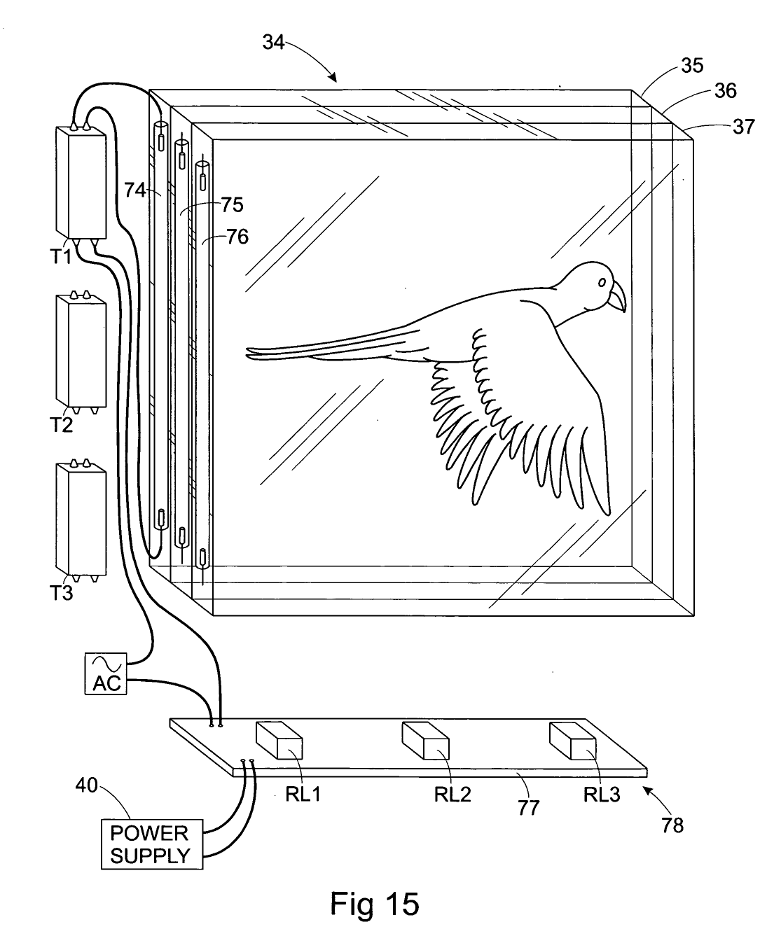

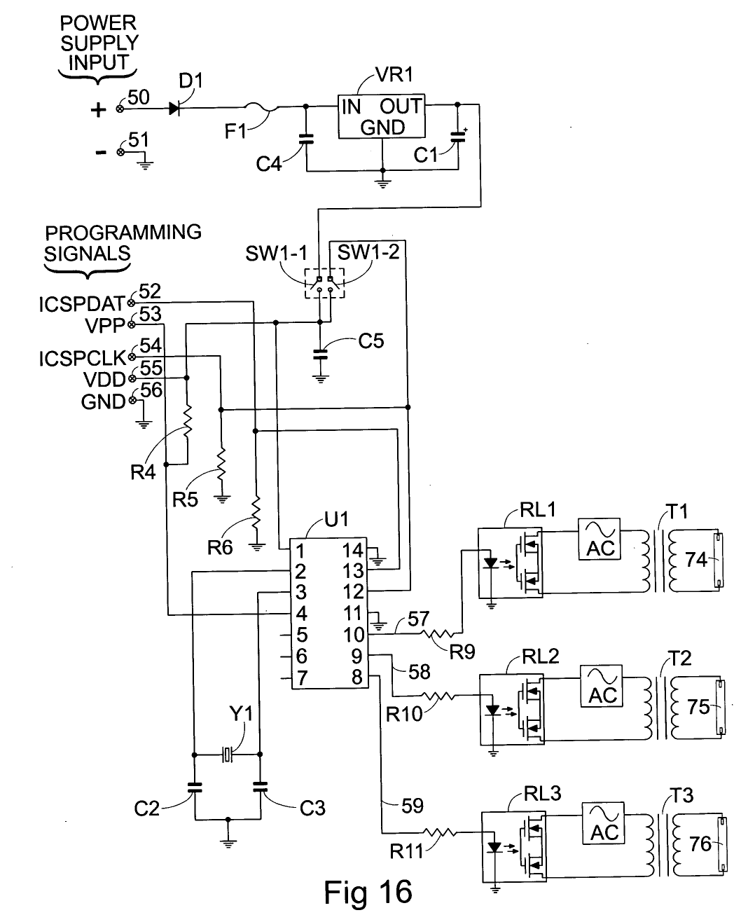

### Description—FIGS. 15 and 16—Second Alternative Embodiment

FIGS. 15 and 16 are an assembled perspective view and schematic diagram for a second alternative embodiment. This second alternative embodiment is nearly identical to the basic embodiment, except that the individual sheets within stack 34 are illuminated by gas-discharge tubes instead of LEDs. In this context, ‘gas-discharge tube’ signifies a clear or fluorescent tube lit with neon, argon-mercury, or other gas. Each sheet still has its own dedicated light source, where in this context ‘light source’ signifies a single tube or set of such tubes lit together as a group.

A fourth electronic assembly 78 is constructed from a fourth PCB 77, a set of optically-coupled solid-state relays RL1 . . . RL3, and additional electronic components (not shown in FIG. 15). Tubes 74 . . . 76 are powered by a set of transformers T1 . . . T3 respectively. For clarity, FIG. 15 only illustrates connecting wires for transformer T1 and tube 74. To ensure that light from each tube only enters its respective sheet, it may be necessary to use light-blocking paint or other means such as staggered sheet edges.

As shown in FIG. 16, relays RL1 . . . RL3 are used instead of transistors to control transformers T1 . . . T3 because standard AC outlet power is switched instead of low-voltage DC power. This is typically 120V, 60 Hz, but that is not a specific requirement. Transformers T1 . . . T3 represent standard neon transformers, electronic neon transformers, or fluorescent tube ballasts. Digital output 57 from microcontroller U1 is connected to relay RL1 through a resistor R9. Relay RL1 energizes transformer TI to illuminate tube 74. Digital output 58 is connected to relay RL2 through a resistor R10. Relay RL2 energizes transformer T2 to illuminate tube 75. Digital output 59 is connected to relay RL3 through a resistor R11. Relay RL3 energizes transformer T3 to illuminate tube 76. Resistors R9 . . . R11 are used as current limiters to supply the correct current to relays RL1 . . . RL3.

This alternative embodiment can not have its brightness diminished by reducing the duty cycle of the digital outputs because it switches relatively slow 60Hz line power. It uses the same program as the basic embodiment. Assembly 78 is connected to the programming hardware and programmed by the same method used to program assembly 39 of the basic embodiment.

See FIG. 15. Tubes 74 . . . 76 are physically attached to stack 34 by any appropriate means (not shown) and electrically connected to transformers T1 . . . T3 and assembly 78. The resulting assemblage is connected to power and is mounted in a suitable base or housing or frame (not shown) to create a complete unit.

### Operation—FIGS. 15 and 16—Second Alternative Embodiment

This alternative embodiment is operated identically to the basic embodiment. Power switch SW1-1 is turned on to sequentially illuminate the light sources. Mode switch SW1-2 must remain in the continuous mode (on) position during operation.

Conclusion, Ramifications, and Scope

Accordingly, the reader will see that this modern microcontroller-based implementation of an animated display has no mechanisms or moving parts of any kind, resulting in lower power consumption, lower cost, increased reliability, simpler manufacturability, and safer operation. It can be scaled from very small to very large without changing its structure or program, by changing only the sheet size and the number of light sources dedicated to each sheet. Furthermore, it has additional advantages in that it
permits the use of low-power high-efficiency light sources instead of hazardous high-power, high-heat projector-style incandescent lamps;
allows completely self-contained battery-powered versions with such low power consumption that they can operate for months on a single set of batteries;
provides additional functionality beyond animation sequencing that is only possible with programmability, such as complex decision-making and timing functions;
provides the inherent flexibility of reprogrammability that isn't available with mechanisms, such as the ability to quickly change animation frame rates, animation interval timing, or other parameters.

Although the above description contains many specific details, these should not be interpreted as limiting the scope of this invention but as simply providing illustrations of the most preferred implementations. Many other variations are possible, for example
using electromechanical or electronic means other than a microcontroller to sequence the animation, such as timers, counters, and relays;
using other types or sizes of light sources from the countless variety available;
using light sources that can dynamically change color;
using a different number of internally-reflective light-transmitting sheets or light sources per sheet;
applying contours or coatings to sheet edges, for example curved edges to receive tubes, or reflective coatings to improve brightness.
using other methods to direct light from the light sources only into their respective sheets, such as staggering the sheet edges so that they're not even, using light-blocking paint, applying bends to one or more sheet edges, or embedding the light sources within the sheets;
using different compositions of internally-reflective light-transmitting material, such as translucent instead of transparent, colored instead of clear, or flexible instead of rigid;
using internally-reflective light-transmitting material in a form other than flat sheets, such as bent sheets, cylindrical sections, or molded shapes;
detecting environmental changes in parameters other than ambient light or sound by using other types of detectors, for example, detecting heat with a thermocouple, or detecting the opening or closing of a door with a door-closure switch.
using other values for programming parameters such as the predetermined animation interval or animation frame rate;
using display behavior other than steadily-diminishing after initiating an animation interval, for example pulsating high and low;
creating different types of animated displays or indicators such as electronic fireworks or eyes that appear to move or blink.

Thus the scope of the invention should not be determined solely by the examples given, but by the appended claims.

I claim:

1. A machine for sequentially displaying a plurality of distinct superimposed images comprising:
(a) a plurality of internally reflective light transmitting sheets,
(b) a distinct pattern representing a distinct image applied to each said sheet,
(c) in combination, a dedicated light source for each said sheet and a means of sequentially illuminating each said light source,
whereby the repetitious sequential illumination of each said light source results in the repetitious sequential illumination of each said pattern to produce an animated display.

2. The machine of claim 1, further including in combination a detector for triggering a predetermined animation interval and a means of adjusting the intensity of said display during said interval.

3. The machine of claim 2, wherein said detector is a light-detecting photocell, whereby said display can be used as an animated nightlight that starts at full brightness but fades away and disappears over said interval after detecting room lights being turned off.

4. The machine of claim 2, wherein said detector is a microphone, further including a voice recognition processor,
whereby said display can be used as an animated nightlight that starts at full brightness but fades away and disappears over said interval after detecting a particular sound, such as a baby crying.

5. The machine of claim 2, wherein said detector is a door closure switch, whereby said display can be used as an animated nightlight or sign that displays an animated image with variable brightness over said interval after detecting the opening or closing of a door.

6. A method for operating an illuminated animated display, comprising the steps of:
(a) provided said display,
(b) provided a means of detecting an environmental change, and
(c) provided a controller which will
i) initiate a predetermined animation interval in response to said environmental change, and
ii) adjust the intensity of said display during said animation interval.

7. The method of claim 6, wherein said environmental change is a change in ambient light,
whereby said display can be used as an animated nightlight that starts at full brightness but fades away and disappears over said interval after detecting room lights being turned off.

8. The method of claim 6, wherein said environmental change is a sound, whereby said display can be used as an animated nightlight that starts at full brightness but fades away and disappears over said interval after detecting a particular sound, such as a baby crying.

9. The method of claim 6, wherein said environmental change is a change in door position,
whereby said display can be used as an animated nightlight or sign that displays an animated image with variable brightness over said interval after detecting the opening or closing of a door.
